(19) United States
(12) Patent Application Publication
(10) Pub. No.: US 2008/0000322 A1
(43) Pub. Date: Jan. 3, 2008

(54) Dual shaft power take-off

(76) Inventors: Harold G. Hillyer, Plain City, OH (US); Juan Torres Pulido, Madrid (ES)

Correspondence Address: DAVID P DURESKA;BUCKINGHAM DOOLITTLE & BURROUGHS, LLP, 4518 FULTON DRIVE, NW, P O BOX 35548, CANTON, OH, 44735-5548, US

(21) Appl. No.: 11/479,913

(22) Filed: Jun. 30, 2006

(51) Int. Cl. F16H 37/06

(52) U.S. Cl. 74/665 G

(57) ABSTRACT

A dual output shaft power take-off includes a rigid housing that is mounted on a vehicle transmission or engine. The housing further includes an input gear that is meshedly engaged with a gear located in the transmission or engine and is rotated when the vehicle is in operation. The housing even further includes a pair of output gears that are meshedly engaged with the input gear and each output gear is supported on an individual output shaft. Each of the output shafts includes an attachment means for attachment of a rotationally driven device. A pair of shifting fork assemblies are located within the housing each of which engages a respective one of the output shafts in order to selectively engage or disengage each output shaft. A pair of switch means are each operatively connected to a respective one of the shifting fork assemblies, so that when the switch is activated, the corresponding output shaft is engaged or disengaged.

### TECHNICAL FIELD

The present invention relates to the art of power take-off units, and more particularly to a dual shaft power take-off unit that is configured for mounting directly on a transmission or engine of a truck, tractor, or other motor vehicle.

### BACKGROUND ART

There are a wide variety of power take-off units which are used in conjunction with the power transmissions of trucks, tractors and other motor vehicles to provide auxiliary rotational power transmission for such things as driving compressors on refrigerated trucks, operating auxiliary farm equipment, operating fire truck accessories, operating tailgates and lifts on trucks including hydraulic lifts freight trucks and dump trucks and the like. More particularly, power take-off units are well known mechanical devices that are commonly used with sources of rotational energy, such as transmissions and vehicle engines, for selectively providing power to one or more rotatably driven accessories. The power take-off unit works in conjunction with the transmission or engine to provide a relatively simple and inexpensive mechanism for supplying rotational power in order to operate a rotatably driven accessory.

The typical power take-off unit will normally include a rigid housing containing a mounting surface formed on the top of the housing unit. An opening is formed through a portion of the mounting surface of the power take-off housing and an input gear is rotatably supported within the housing and includes a portion that extends outwardly through the opening formed in the mounting surface. The mounting surface of the power take-off unit housing is adapted to be attached, typically by a plurality of bolts or studs, to a corresponding mounting surface formed on the outer case of a transmission or engine provided on the vehicle. A corresponding opening is also formed through a portion of the mounting surface of the transmission case. When the power take-off unit housing is mounted on the transmission case, the input gear of the power take-off, which is extending through the opening formed through the housing of the power take-off unit, further extends into the opening in the transmission case into meshing engagement with one of the transmission gears. This transmission gear is generally driven by the vehicle engine. As a result, the input gear of the power take-off unit is rotatably driven whenever the vehicle engine is operated.

The power take-off unit also typically includes an output gear assembly that is rotatably supported within the housing. The input gear, described in detail above, meshes with the output gear so that the output gear is also rotatably driven when the vehicle engine is in operation. The output gear is placed upon and is supported by an output shaft that is in turn rotatably supported in the bottom portion of the housing unit. The output shaft extends generally outwardly from the housing of the power take-off unit and includes a spline in its outward facing end for connection with a rotatably driven accessory. The output gear can be attached directly to the output shaft in which case, the output shaft is rotatably driven directly by the output gear when the vehicle engine is operating. In other instances, the output gear may be connected through a clutch assembly to the output shaft. The clutch assembly is also contained within the power take-off housing for selectively connecting the output gear to the output shaft and, therefore, permitting selective or intermittent operation of the rotatably driven accessory whenever the vehicle engine is in operation.

A derivative of the single-shaft output power take-off described above is the dual shaft output power take-off. The dual-shaft power take-off originated as a result of the increased demand for additional rotatably driven accessories to be attached to an individual opening in a transmission or vehicle engine. State of the art transmissions generally include two openings in the transfer case on which power take-offs or other devices may be mounted to harness the rotational energy of the transmission. However, many state-of-the-art transmission builders and manufacturers are now using a type of automatic shifting system on their transmissions that uses one of the openings on the transmission that would otherwise be available for a power-take-off unit. Therefore, vehicles using these types of automatic shifting systems are limited to only one opening on the transmission for attachment of a power take-off unit. As a result, power take-off units with two output shafts have been developed for use where there are limitations on the number of openings available in the transmission. References herein to a dual shaft power take-off or a dual output shaft power take-off are synonymous with one another and refer to a power take-off having two output shafts. These prior art dual shaft power take-off units have been relatively limited in their usefulness because operation of the dual shafts has lacked both versatility and flexibility. For instance, one such prior art dual-shaft power take-off unit contains two shafts that turn in opposite directions. Another prior art dual-shaft power take-off contains two output shafts that turn in a common singular direction, but only one output shaft may be operated at any one time. As a result, only one rotationally driven accessory can be used at a given time. This greatly limits the versatility and flexibility with which the operator can use the rotationally driven accessories.

Thus a need exists in the art for a dual shaft power take-off that overcomes the problems and deficiencies of the prior art by allowing for selective independent activation of either output shaft as well as collective activation of both shafts at the same time in order to provide vehicle owners with greater flexibility and versatility in operating the rotationally driven accessories that may be used in conjunction with the power take-off unit.

### BRIEF SUMMARY OF THE INVENTION

An objective of the present invention is to provide a power take-off that is mountable to a single opening in a vehicle transmission and that includes dual output shafts for attachment of two separate rotationally driven accessories.

Another objective of the present invention is to provide a dual output shaft power take-off that is mountable to a single opening in a vehicle transmission wherein the dual output shafts are selectively operable, for example, one or both of the output shafts can be operated at the same time or independently of one another.

These objectives and others are obtained by the dual shaft power take-off that is mountable to a single opening in a vehicle transmission of the present invention, the general nature of which may be stated as including: 1) a housing; 2) an input gear supported within the housing and extending through an opening in the housing for mounting onto and engaging a vehicle transmission, vehicle engine or other device that creates rotational energy; 3) a pair of output gears, also included within the housing, each of which is meshedly engaged with the input gear and supported on respective one of a pair of output shafts, providing a means for transferring the rotational energy obtained from the transmission into rotational energy for the two output shafts; 4) a pair of control means each attached to a respective one of the output shafts for controlling the engagement and disengagement of each output shaft; and 5) a pair of switch means operatively connected to a respective one of the control means each of which have two states, one corresponding to the output shaft being in an engaged position and one corresponding to the output shaft being in a disengaged position.

### BRIEF DESCRIPTION OF THE SEVERAL VIEWS OF THE DRAWINGS

The preferred embodiment of the invention, illustrative of the best mode in which applicants have contemplated applying the principles of the invention, is set forth in the following description and is shown in the drawings, and is particularly and distinctly pointed out and set forth in the appended claims.

FIG. 1. is an exploded view of a prior art single-shaft power take-off unit, showing the housing unit, the input gear assembly, the switch fork assembly and the output shaft assembly.

FIG. 2 is a side sectional view of the single-shaft power take-off unit of FIG. 1.

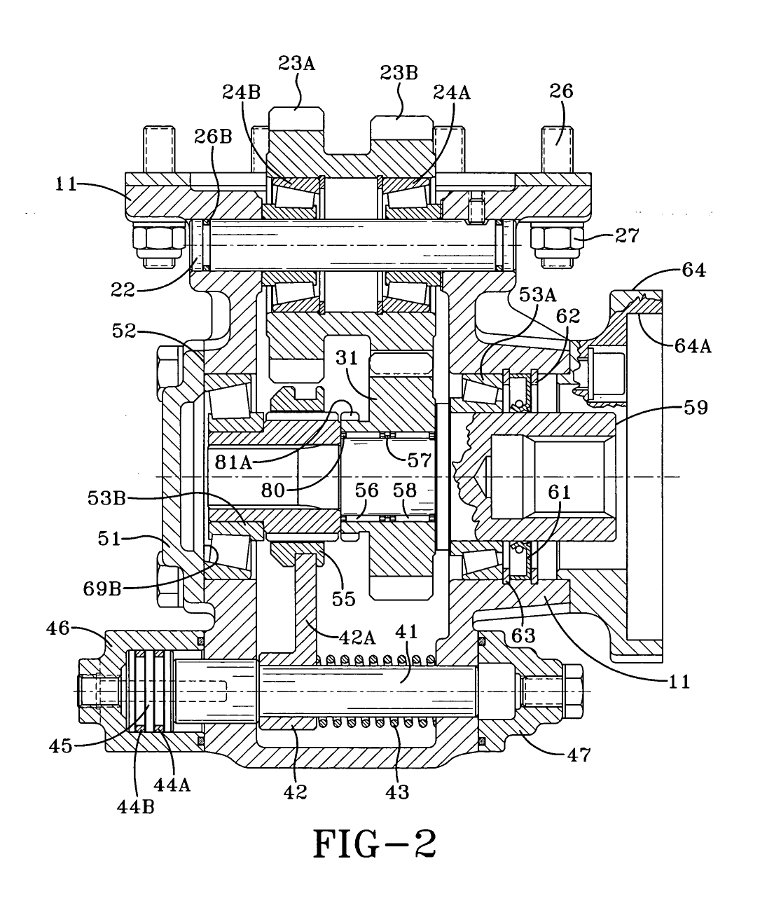

FIG. 3 is an exploded view of the dual output shaft power take-off of the present invention showing the input gear assembly and the pairs of switchfork assemblies and output shaft assemblies.

FIG. 3A is an enlarged exploded view of the rear portion of the dual output shaft power take-off shown in FIG. 3.

FIG. 3B is an enlarged exploded view of the front portion of the dual output shaft power take-off shown in FIG. 3.

FIG. 4 is a top sectional view of the dual output shaft of FIG. 3.

Similar numerals refer to similar parts throughout the drawings.

### DETAILED DESCRIPTION OF THE INVENTION

So that the improved power take-off of the present invention can be best understood, a prior art power take-off will be described first.

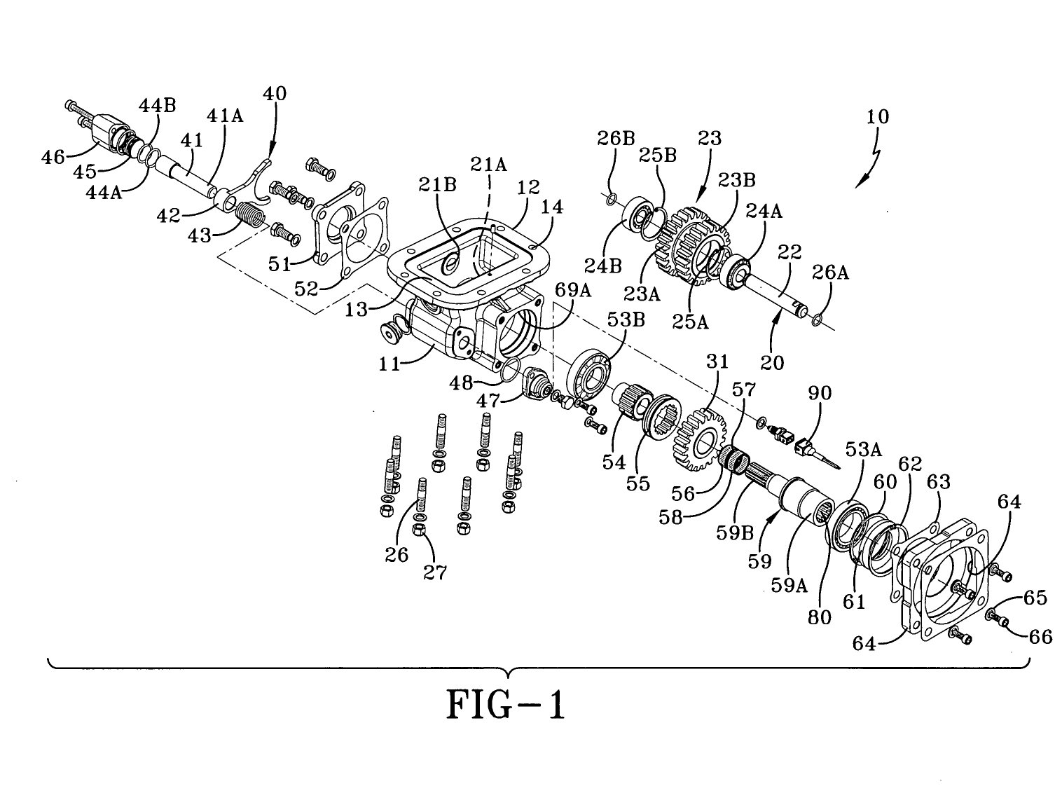

For purposes of illustration, a conventional prior art power take-off unit 10 is shown in FIG. 1. Power take-off unit 10 generally includes a rigid housing 11, an input gear 23, an output gear 31, a shift fork assembly 40, and an output shaft 59 which attaches to a rotationally driven accessory such as: a hydraulic pump, compressors on refrigerated trucks, auxiliary farm equipment, fire truck accessories, tailgates and lifts on trucks and the like.

More particularly, housing 11 includes an integrally formed mounting plate 12 that surrounds a generally rectangular shaped opening 13 which is located on the top surface of the housing. Specifically, mounting plate 12 includes a generally flat top surface with a plurality of circular openings 14 through which a plurality of sealed studs 26 are vertically disposed in order to attach housing 11 to a vehicle transmission or engine (not shown). A plurality of bolts 27 are threadably attached to the lower ends of each of studs 26 in order to secure the housing 11 to the transmission or engine in a manner well known in the art.

An input gear assembly 20 is horizontally supported in the housing 11 by a pair of aligned openings 21A, B formed through the front and rear faces of the housing of the power take-off unit 10. More particularly, input gear assembly 20 includes an input shaft 22 that is horizontally disposed through openings 21A, B. Openings 21A, B are transversely aligned and located in the upper medial portion of the front and rear faces of housing 11. An input gear 23 having a first toothed portion 23A and a second toothed portion 23B, is rotatably supported on the input shaft 22 by a pair of bearings 24 A, B, a pair of Seeger rings 25 A, B, and a pair of O-rings 26A, B, respectively, in a manner well known in the art. The first toothed portion 23A of input gear 23 extends generally upwardly through the opening 13 in the housing 11 of the power take-off unit 10. When power take-off unit 10 is mounted on a vehicle transmission (not shown), the first toothed portion 23A of input gear 23 meshedly engages with one of the rotatably driven gears of the vehicle transmission (not shown), so that input gear 23 is rotatably driven whenever the vehicle engine is in operation.

Additionally, an output gear 31 is also contained within the housing 11 of power take-off unit 10. More particularly, the output gear 31 is rotatably supported on the output shaft 59. Output gear 31 meshedly engages with the second toothed portion 23B of input gear 23, so that output gear 31 is rotatably driven by input gear 23 when the vehicle engine is in operation.

An output shaft assembly 50 is also included within the housing 11 of power take-off unit 10. The output shaft assembly 50 includes: blank cover 51, gasket 52, roller bearing 53A,B, gear bush 54, engaging dog 55, needle bearing 56, spacer bush 57, needle bearing 58, output shaft 59, Seeger ring 60, BASL seal 61, Seeger ring 62, gasket 63, adapter flange 64, washers 65, nuts 66 and front and rear openings 69A,B. More specifically, output shaft 59 includes a pair of ends 59A, B, each of which is rotatably supported by a respective one of a pair of bearings 53A,B each of which is placed in a respective one of the openings 69A, B which are located in the front and rear walls, respectively, of the housing unit 11. The power end 59A of the output shaft 59 which extends toward the front of the housing unit 11 includes in an internal spline 80 to facilitate a connection with a rotatably driven accessory. An adapter flange 64 is transversely aligned with the output shaft 59 and is mounted on the front surface of the housing 11 on studs 15 with a plurality of washers 65 and nuts 66 in a manner well known in the art. The power end 59A of the output shaft 59 is rotatably supported on a roller bearing 53A, which is in turn nested along with a first Seeger ring 60, a BASL seal 61, and a second Seeger ring 62 into a circular recess 91 integrally formed in the front wall of housing 11 around opening 69A, in a manner well known in the art and rotatably supports the power end 59A of the output shaft 59. Adapter flange 64 contains a circular opening 64A that allows access to the power end 59A of the output shaft 59. Blank cover 51 is attached by screws 67 or other suitable means of attachment to the back of housing 11 over opening 69B. A gasket 52 is disposed between blank cover 51 and the back surface of the housing 11 in order to prohibit fluid from leaking out of the housing. A roller bearing 53B is nested in the opening 69B of the housing 11 against blank cover 51. The gear bush 54 is rotatably supported within roller bearing 53B and is disposed on and meshedly engages through an internal spline 54A with the rear end 59B of the output shaft 59. Therefore, when gear bush 54 is rotated, the output shaft 59 is also rotated. The engaging dog 55, in turn, is placed on and around and meshedly engages with the gear bush 54. Engaging dog 55 includes an outer groove 55A around its circumference. Output gear 31 is rotatably disposed upon the needle bearing 58 which is in turn disposed on and around the output shaft 59 adjacent to and in front of the gear bush 54. Needle bearing 58 allows output gear 31 to rotate freely about output shaft 59.

A shift fork assembly 40 is also included within the housing 11 and is used for mechanically engaging or disengaging the output shaft 59. Shift fork assembly 40 includes: a shifter shaft 41, a fork 42, a spring piston 43, a pair of O-rings 44A, B, a piston 45, a piston carrier cover 46, a switch carrier cover 47, and a switch carrier cover gasket 48. More specifically, shifter shaft 41 has a forward end 41A that nests in the switch carrier cover 47 aligned with opening 49A and mounted with switch carrier cover gasket 48 on the front surface of housing 11 with a pair of bolts, in a manner well known in the art. Shifter shaft 41 further includes a rearward end 41B which is nested along with O-ring 44A within piston 45. Piston 45 is in turn nested along with O-ring 44B in the piston carrier cover 46 through opening 49B located on the rear face of housing 11 and which is transversely aligned with opening 49A located on the front surface of the housing. Piston carrier cover 46 is attached to the housing 11 with a pair of bolts, in a manner well known in the art. Shifting fork 42 is slidably disposed around shifter shaft 41, allowing the shifting fork to move axially along the length of the shifter shaft. Shifting fork 42 further includes a fork end 42A that extends perpendicularly outwardly from the shifter shaft toward output shaft assembly 50 and engages the outer groove 55A of engaging dog 55 located on the output shaft 59. A spring piston 43 is also disposed around the shifter shaft 41 between the shifting fork 42 and the switch carrier cover 47. The spring piston 43 springably engages shifting fork 42 and urges shifting fork 42 in a rearward direction which corresponds with the disengaged status of the output shaft. A switch 90 is attached to switch carrier cover 28. The indicator switch 90 is in turn electrically connected to an indicator light (not shown) located in the cab of the truck. When the switch means (not shown), which is operatively connected to the piston carrier cover 46, is switched “on”, which corresponds to activation of the output shaft, the indicator switch 90 and the indicator light are lit to show the individual in the cab of the truck that the output shaft is engaged.

More particularly when the switch means is activated, piston 45 is urged forwardly and shifting fork 42 is moved axially along the shifter shaft 41 and urges engaging dog 55 also axially forwardly. As a result, engaging dog 55 meshes with the toothed portion 31A on the rear side of output gear 31. In this activated state, the engaging dog 55 meshes with both the toothed portion 31A of the rotating output gear 31 as well as the gear bush 54. Because output gear 31 is always rotating when the transmission or engine is being operated, when engaging dog 55 is meshed with the rear toothed portion 31A of the rotating output gear, engaging dog 55 also rotates which in turn causes gear bush 54 and output shaft 59 to rotate, allowing for an attachment that is engaged with the internal spline 80 of the output shaft to be rotationally driven. Therefore, when switch means 96 is in an “on” or activated position, output shaft 59 is rotated.

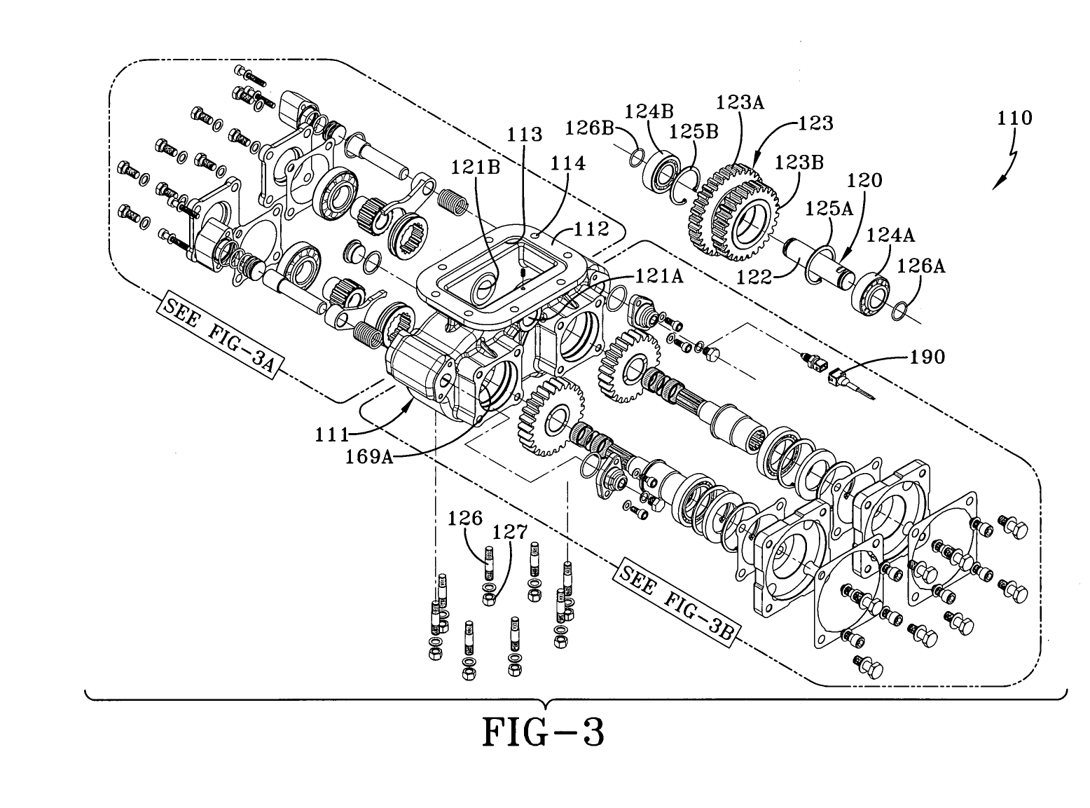

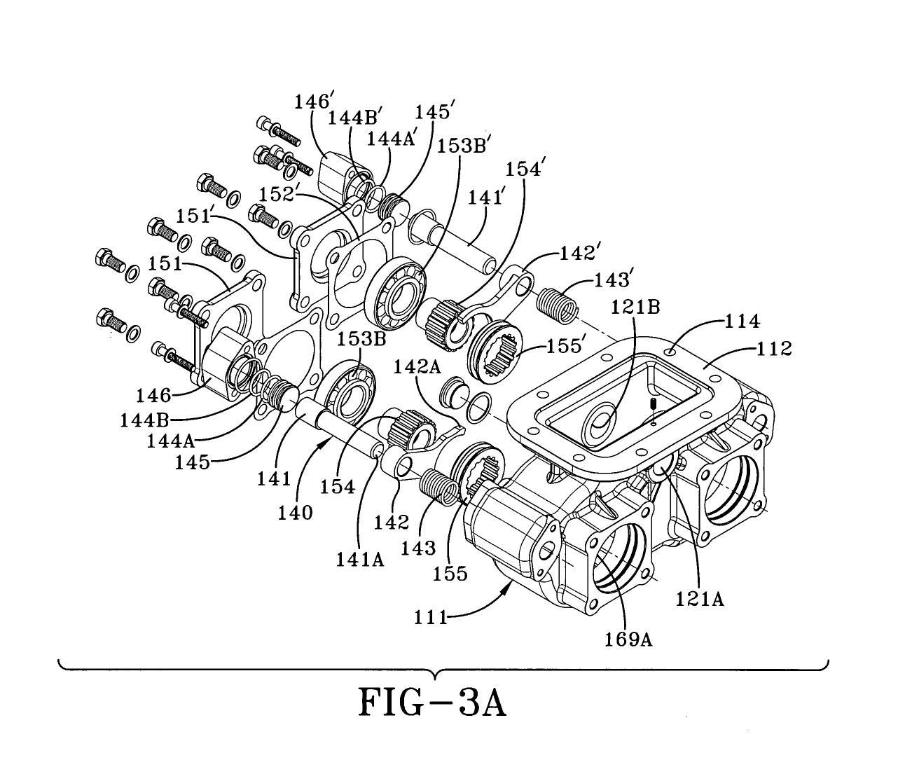

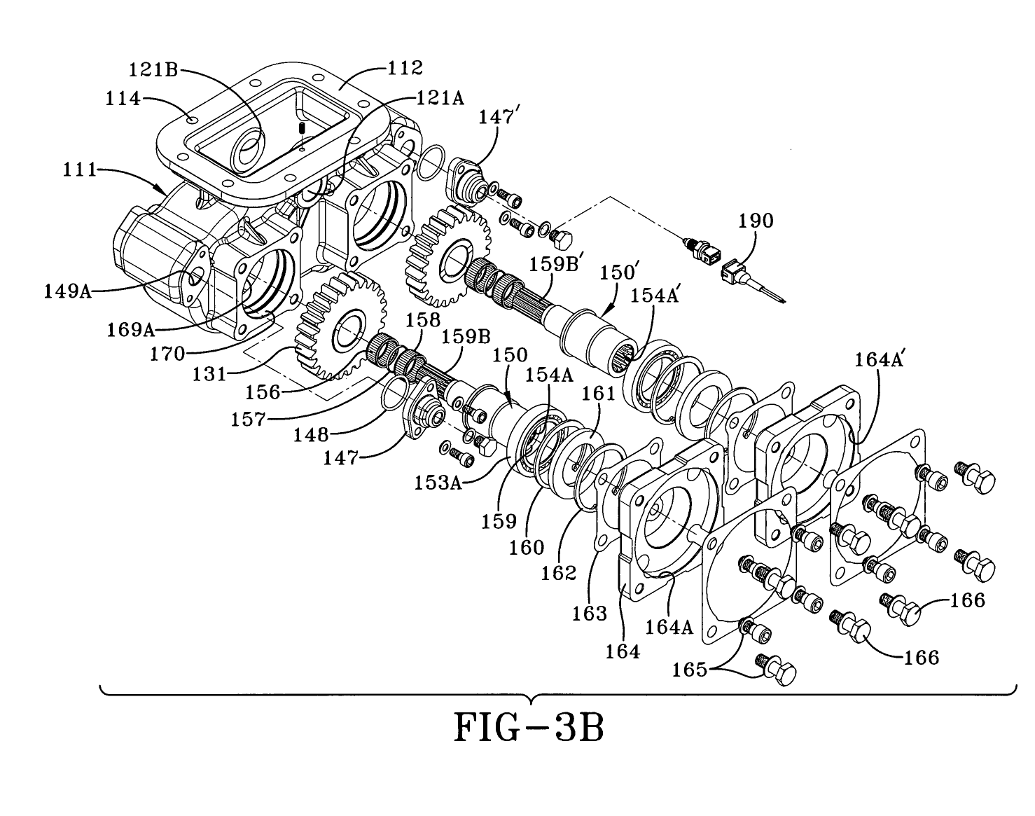

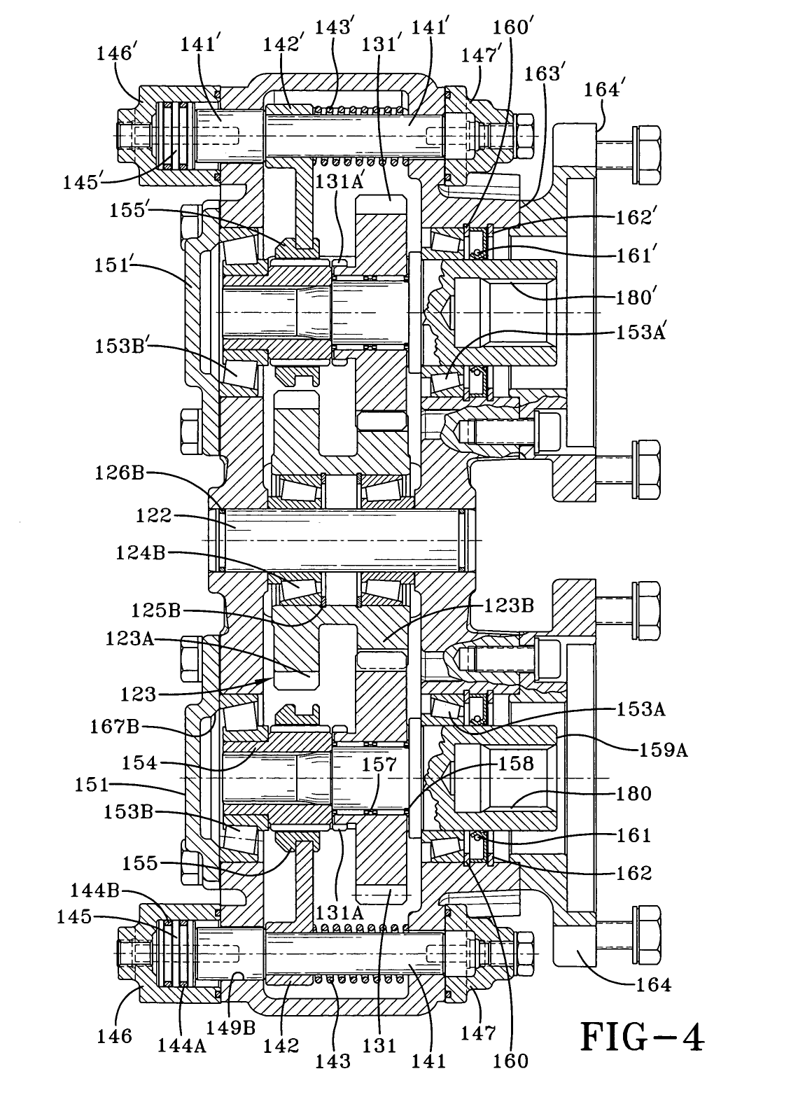

Turning now to FIG. 3, wherein the illustrations are provided to show a preferred embodiment of the invention and not to limit the same, a dual output shaft power take-off 110 for mounting on an individual opening of a vehicle transmission is shown generally in FIGS. 3 and 4.

Dual power take-off unit 110 generally includes a rigid housing 111, an input gear 123, a pair of output gears 131 and 131′, a pair of shift fork assemblies 140 and 140′, and a pair of output shafts 159 and 159′ which attach to rotationally driven accessories such as: a hydraulic pumps, compressors on refrigerated trucks, auxiliary farm equipment, fire truck accessories, tailgates and lifts on trucks and the like.

More particularly, housing 111 includes an integrally formed mounting plate 112 that surrounds a generally rectangular shaped opening 113 which is located on the top surface of the housing. Specifically, mounting plate 112 includes a generally flat top surface with a plurality of circular openings 114 through which a plurality of sealed studs 126 are vertically disposed in order to attach housing 111 to a vehicle transmission or engine (not shown). A plurality of bolts 127 are threadably attached to the lower ends of each of studs 126 in order to secure the housing 111 to the transmission or engine in a manner well known in the art, keeping in mind that multiple bolt patterns are contemplated by the present invention and include 4,6,7,8, and 10 bolt pattern configurations based upon the particular mounting configuration used by the individual transmission manufacturers.

An input gear assembly 120 is horizontally supported in the housing 111 by a pair of aligned openings 121A, B formed through the front and rear faces of the housing of the power take-off unit 110. More particularly, input gear assembly 120 includes an input shaft 122 that is horizontally disposed through openings 121A, B. Openings 121A, B are transversely aligned and located in the upper medial portion of the front and rear faces of housing 111. An input gear 123 having a first toothed portion 123A and a second toothed portion 123B, is rotatably supported on the input shaft 122 by a pair of bearings 124 A, B, a pair of Seeger rings 125 A, B, and a pair of O-rings 126A, B, respectively, in a manner well known in the art. The first toothed portion 123A of input gear 123 extends generally upwardly through the opening 113 in the housing 111 of the power take-off unit 110. When power take-off unit 110 is mounted on a vehicle transmission (not shown), the first toothed portion 123A of input gear 123 meshedly engages with one of the rotatably driven gears of the vehicle transmission (not shown), so that input gear 123 is rotatably driven whenever the vehicle engine is in operation.

Because the present invention includes a dual output shaft configuration, each of the output gears, output shaft assemblies, and shifting fork assemblies being identical, only one of each of the output gears, output shaft assemblies, and shifting fork assemblies will be described in detail below. However, it should be noted that the sides have been labeled with and without' designations(“'”) in the drawings and the detailed description that follows applies equally to both' and non-' part designations. For example, a reference to output gear 131 refers equally to output gear 131′ located on the opposite side of the drawing.

An output gear 131 is also contained within the housing 111 of power take-off unit 110. More particularly, the output gear 131 is rotatably supported on the output shaft 159. Output gear 131 meshedly engages with the second toothed portion 123B of input gear 123, so that output gear 131 is rotatably driven by input gear 123 when the vehicle engine is in operation.

An output shaft assembly 150 is also included within the housing 111 of power take-off unit 110. The output shaft assembly 150 includes: blank cover 151, gasket 152, roller bearings 153A,B, gear bush 154, engaging dog 155, needle bearing 156, spacer bush 157, bearing 158, output shaft 159, Seeger ring 160, BASL seal 161, Seeger ring 162, gasket 163, adapter flange 164, washers 165, nuts 166, front and rear openings 169A,B, and attachment means 180. More specifically, output shaft 159 includes a pair of ends 159A, B, each of which is rotatably supported by a respective one of a pair of bearings 153A,B each of which is placed in a respective one of the openings 169A, B which are located in the front and rear walls, respectively, of the housing unit 111. The power end 159A of the output shaft 159 which extends toward the front of the housing unit 111 includes in an internal spline 180 to facilitate a connection with a rotatably driven accessory. An adapter flange 164 is transversely aligned with the output shaft 159 and is mounted on the front surface of the housing 111 on studs 115 with a plurality of washers 165 and nuts 166 in a manner well known in the art. The power end 159A of the output shaft 159 is rotatably supported on a bearing 153A, which is in turn nested along with a first Seeger ring 160, a BASL seal 161, and a second Seeger ring 162 into a circular recess 191 integrally formed in the front wall of housing 111 around opening 169A, in a manner well known in the art and rotatably supports the power end 159A of the output shaft 159. Adapter flange 164 contains a circular opening 164A that allows access to the power end 159A of the output shaft 159. Blank cover 151 is attached by screws 167 or other suitable means of attachment to the back of housing 111 over opening 169B. A gasket 152 is disposed between blank cover 151 and the back surface of the housing 111 in order to prohibit fluid from leaking out of the housing. A bearing 153B is nested in the opening 169B of the housing 111 against blank cover 151. The gear bush 154 is rotatably supported within bearing 153B and is disposed on and meshedly engages through an internal spline 154A with the rear end 159B of the output shaft 159. Therefore, when gear bush 154 is rotated, the output shaft 159 is also rotated. The engaging dog 155, in turn, is placed on and around and meshedly engages with the gear bush 154. Engaging dog 155 includes an outer groove 155A around its circumference. Output gear 131 is rotatably disposed upon the bearing 158 which is in turn disposed on and around the output shaft 159 adjacent to and in front of the gear bush 154. Bearing 158 allows output gear 131 to rotate freely about output shaft 159.

A shift fork assembly 140 is also included within the housing 11 and is used for mechanically engaging or disengaging the output shaft 159. Shift fork assembly 140 includes: a shifter shaft 141, a fork 142, a spring piston 143, a pair of O-rings 144A, B, a piston 145, a piston carrier cover 146, a switch carrier cover 147, and a switch carrier cover gasket 148. More specifically, shifter shaft 141 has a forward end 141A that nests in the switch carrier cover 147 aligned with opening 149A and mounted with switch carrier cover gasket 148 on the front surface of housing 111 with a pair of bolts, in a manner well known in the art. Shifter shaft 141 further includes a rearward end 141B which is nested along with O-ring 144A within piston 145. Piston 145 is in turn nested along with O-ring 144B in the piston carrier cover 146 through opening 149B located on the rear face of housing 111 and which is transversely aligned with opening 149A located on the front surface of the housing. Piston carrier cover 146 is attached to the housing 111 with a pair of bolts, in a manner well known in the art. Shifting fork 142 is slidably disposed around shifter shaft 141, allowing the shifting fork to move axially along the length of the shifter shaft. Shifting fork 142 further includes a fork end 142A that extends perpendicularly outwardly from the shifter shaft toward output shaft assembly 150 and engages the outer groove 155A of engaging dog 155 located on the output shaft 159. A spring piston 143 is also disposed around the shifter shaft 141 between the shifting fork 142 and the switch carrier cover 147. The spring piston 143 springably engages shifting fork 142 and urges shifting fork 142 in a rearward direction which corresponds with the disengaged status of the output shaft.

An indicator switch 190 is attached to switch carrier cover 128. The indicator switch 190 is in turn electrically connected to an indicator light (not shown) located in the cab of the truck. When the switch means (not shown) is switched “on”, which corresponds to activation of the output shaft, the indicator switch 190 is activated and the indicator light is lit to show an individual in the cab of the vehicle that the output shaft is engaged. Switch means can be any one of a number of controlling mechanisms that are generally well known in the art including: an air toggle switch, toggle switch, electric rocker switch, or push-pull mechanical switch. More particularly when the switch means is activated, piston 145 is urged forwardly and shifting fork 142 is moved axially along the shifter shaft 141 and urges engaging dog 155 also axially forwardly. As a result, engaging dog 155 meshes with the toothed portion 131A on the rear side of output gear 131. In this activated state, the engaging dog 155 meshes with both the toothed portion 131A of the rotating output gear 131 as well as the gear bush 154. Because output gear 131 is always rotating when the transmission or engine is being operated, when engaging dog 155 is meshed with the rear toothed portion 131A of the rotating output gear, engaging dog 155 also rotates which in turn causes gear bush 154 and output shaft 159 to rotate, allowing for an attachment that is engaged with the attachment means 180 of the output shaft to be rotationally driven, keeping in mind that there are a number of well known attachment means including both splines and drive shafts, all of which are contemplated by the present invention. Therefore, when switch means is in an “on” or activated position, output shaft 159 is rotated.

Accordingly, the power take-off of the present invention is simplified, provides an effective, safe, inexpensive, and efficient structure which achieves all of the enumerated objectives, provides for elimination of difficulties encountered with the prior-art power take-offs, and solves problems and obtains new results in the art.

In the foregoing description, certain terms have been used for brevity, clearness, and understanding; but no unnecessary limitations are to be implied therefrom beyond the requirements of the prior art, because such terms are used for descriptive purposes and are intended to be broadly construed.

Moreover, the description and illustration of the invention is by way of example, and the scope of the invention is not limited to the exact details shown or described.

Having now described the features, discoveries and principles of the invention, the manner in which the improved power take-off is constructed, arranged and used, the characteristics of the construction and arrangement, and the advantageous, new and useful results obtained; the new and useful steps, structures, devices, elements, arrangements, parts and combinations, are set forth in the appended claims.

What is claimed is:

1. A dual-output shaft power take-off for a vehicle transmission comprising:
a housing that includes:
an input gear assembly, including an input gear rotatably mounted on an input shaft;
a pair of output gears each of which is meshedly engaged with said input gear and each of which is mounted on a respective one of a pair of output shafts, each of said output shafts including an attachment means whereby a rotationally driven device can be attached thereto in order to provide rotational energy to said rotationally driven device;
a pair of control means each of which is engaged with a respective one of said output shafts for selectively engaging and disengaging said output shafts; and
a pair of switch means each of which is operatively connected to a respective one of said control means and each of which has at least two states, one of said states corresponding to said output shaft being in an engaged position and the other of said states corresponding to said output shaft being in a disengaged position.

2. The dual-output shaft power take-off of claim 1, wherein each of said pair of control means includes a shift fork assembly.

3. The dual-output power take-off of claim 2, wherein said shift fork assembly includes a shifting fork moveably supported on a shifter shaft, said shifting fork engaging an engaging dog that is moveably supported on said output shaft and having at least two states, one of said states corresponding to an activated position whereby said engaging dog meshedly engages both said output gear and said output shaft so that when said output gear is rotated said output shaft is also rotated, the other of said states corresponding to a deactivated position whereby said engaging dog meshedly engages said output shaft only.

4. The dual-output power take-off of claim 1, wherein said switch means is located in the cab of the vehicle.

5. The dual-output power take-off of claim 1, wherein said switch means is selected from a group consisting of: a toggle switch, an electric rocker switch, an air toggle switch, and a push-pull mechanical switch.

6. A dual-output power take-off for a vehicle transmission comprising:
a housing that includes:
an input gear assembly, including an input gear rotatably mounted on an input shaft;
a pair of output gears each of which is meshedly engaged with said input gear and each of which is mounted on a respective one of a pair of output shafts, each of said output shafts including a spline whereby a rotationally driven device can be attached thereto in order to provide rotational energy to said rotationally driven device;
a pair of control means each of which is engaged with a respective one of said output shafts for selectively engaging and disengaging said output shafts, said control means further comprising a shifting fork moveably supported on a shifter shaft, said shifting fork engaging an engaging dog that is moveably supported on said output shaft and having at least two states, one of said states corresponding to an activated position whereby said engaging dog meshedly engages both said output gear and said output shaft so that when said output gear is rotated said output shaft is also rotated, the other of said states corresponding to a deactivated position whereby said engaging dog meshedly engages said output shaft only; and
a pair of switch means each of which is operatively connected to a respective one of said control means and each of which has at least two states, one of said states corresponding to said output shaft being in an engaged position and the other of said states corresponding to said output shaft being in a disengaged position.
